(19) United States
(12) Patent Application Publication
(10) Pub. No.: US 2024/0047693 A1
(43) Pub. Date: Feb. 8, 2024

(54) ELECTRODE ASSEMBLIES PREPARED USING DIFFUSION COUPLING

(71) Applicant: GM GLOBAL TECHNOLOGY OPERATIONS LLC, Detroit, MI (US)

(72) Inventors: Jeffrey David CAIN, Royal Oak, MI (US); Thomas E. MOYLAN, Troy, MI (US); Caleb REESE, Ferndale, MI (US); Sayed Youssef Sayed NAGY, Troy, MI (US); Andrew Clay BOBEL, Troy, MI (US)

(73) Assignee: GM GLOBAL TECHNOLOGY OPERATIONS LLC, Detroit, MI (US)

(21) Appl. No.: 17/879,419

(22) Filed: Aug. 2, 2022

(51) Int. Cl. H01M 4/66; H01M 4/04

(52) U.S. Cl. CPC H01M 4/661; H01M 4/0471; H01M 4/0423

(57) ABSTRACT

An electrode assembly that includes a current collector, a lithium foil, and a solid solution interface that chemically binds the current collector and the lithium foil is provided. The solid solution interface includes a portion of the current collector that is impregnated with lithium atoms diffused from the lithium foil. In some variations, a method for forming the electrode assembly includes heating a precursor electrode assembly that includes a current collector and a lithium metal film to a temperature that is less than a melting point of lithium, so that lithium atoms diffuse into the current collector during the heating. In other variations, a method for forming the electrode assembly includes disposing a molten lithium onto a heated current collector to form a precursor electrode assembly, and cooling the assembly to form a lithium metal layer that is chemically bonded to the current collector.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Many different materials may be used to create components for a lithium-ion battery. For example, the negative electrode may be defined by a lithium-containing material, such as metallic lithium, so that the electrochemical cell is considered a lithium metal battery or cell. Metallic lithium for use in the negative electrode of a rechargeable battery has various potential advantages, including having the highest theoretical capacity and lowest electrochemical potential. Thus, lithium metal batteries are one of the most promising candidates for high energy storage systems. However, lithium metal does not readily adhere to common current collector materials, such as copper, using different physical or mechanical techniques, and so often result in delamination and diminished performance and/or potential premature electrochemical cell failure. Accordingly, it would be desirable to develop materials for use in high energy lithium-ion batteries that improve adhesion, and as such, cell performance.

### SUMMARY

This section provides a general summary of the disclosure, and is not a comprehensive disclosure of its full scope or all of its features.

The present disclosure relates to electrode assemblies having nano-scale solid solution interfaces binding current collectors and electroactive material layers, and also to methods of making and using the same.

In various aspects, the present disclosure provides an electrode assembly for an electrochemical cell that cycles lithium ions. The electrode assembly may include a current collector, a lithium metal foil, and a solid solution interface that chemically binds the current collector and the lithium metal foil. The solid solution interface may include a first portion of the current collector that is impregnated with lithium atoms diffused from the lithium metal foil.

In one aspect, the current collector may have an average thickness greater than or equal to about 3 μm to less than or equal to about 80 μm, and the solid solution interface may impregnate greater than or equal to about 0.05% to less than or equal to about 1.5% of the average thickness of the current collector.

In one aspect, the lithium metal foil may have an average thickness greater than or equal to about 1 micrometer to less than or equal to about 100 micrometers.

In one aspect, the current collector may include copper.

In one aspect, the current collector may further include zinc, tin, lead, gold, indium, nickel, silicon, or combinations thereof.

In various aspects, the present disclosure provides a method of preparing an electrode assembly for an electrochemical cell that cycles lithium ions. The method may include heating a precursor electrode assembly that includes a current collector and a lithium metal film disposed on one or more surfaces of the current collector to a temperature that is less than a melting point of lithium, so that lithium atoms from the lithium metal film diffuse into the current collector during the heating forming a solid solution interface that chemically binds the current collector and the lithium metal foil to form the electrode assembly.

In one aspect, the temperature may be greater than or equal to about 120° C. to less than or equal to about 180° C.

In one aspect, the temperature may be maintained for a period greater than or equal to about 30 seconds to less than or equal to about 3 hours.

In one aspect, the lithium metal film may have a thickness greater than or equal to about 1 micrometer to less than or equal to about 100 micrometers.

In one aspect, the method may further include preparing the precursor electrode assembly. The precursor electrode assembly may be prepared by disposing the lithium metal film onto the one or more surfaces of the current collector using, for example, a physical vapor deposition (PVD) process, an electrodeposition process, or a lamination process.

In one aspect, the lithium metal film may be an ultrathin lithium metal film having an average thickness greater than or equal to about 1 nanometer to less than or equal to about 110 nanometers.

In one aspect, the method may further include preparing the electrode assembly by disposing the ultrathin lithium metal film onto the one or more surfaces of the current collector using an electrodeposition process.

In one aspect, the average thickness may be a first average thickness, the ultrathin lithium metal film may be a first lithium metal film, and the method may further include, after the heating, disposing a second lithium metal film onto the solid solution interface. The second lithium metal film may have a second average thickness that is greater than the first average thickness.

In one aspect, the second average thickness may be greater than or equal to about 1 micrometer to less than or equal to about 100 micrometers.

In one aspect, the current collector may have an average thickness greater than or equal to about 5 micrometers to less than or equal to about 80 micrometers, and the solid solution interface may impregnate greater than or equal to about 0.05% to less than or equal to about 1.5% of the average thickness of the current collector.

In one aspect, the current collector may include copper.

In various aspects, the present disclosure provides a method of preparing an electrode assembly for an electrochemical cell that cycles lithium ions. The method may include disposing a molten lithium onto one or more surfaces of a heated current collector to form a precursor electrode assembly, and cooling the precursor electrode assembly to form a lithium metal layer that is chemically bonded to the one or more surfaces of the current collector via a solid solution interface and defines the electrode assembly.

In one aspect, during the disposing, the molten lithium may have a first temperature greater than or equal to about 180° C. to less than or equal to about 250° C., and the heated precursor current collector may have a second temperature greater than or equal to about 120° C. to less than or equal to about 250° C.

In one aspect, the cooling may occur at a rate greater than or equal to about 5° C./sec to less than or equal to about 50° C./sec.

In one aspect, the current collector may have an average thickness greater than or equal to about 5 micrometers to less than or equal to about 80 micrometers, and the solid solution interface may impregnate greater than or equal to about 0.05% to less than or equal to about 1.5% of the average thickness of the current collector.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical cell having an electrode assembly having a nano-scale solid solution interface binding a current collector and an electroactive material layer in accordance with various aspects of the present disclosure;

FIG. 2 is a flowchart illustrating an example method for forming an electrode assembly having a nano-scale solid solution interface binding a current collector and an electroactive material layer in accordance with various aspects of the present disclosure;

FIG. 3A is a graphical illustration demonstrating the depth of diffusion of lithium atoms into a current collector defining a nano-scale solid solution interface in accordance with various aspects of the present disclosure;

FIG. 3B is another graphical illustration demonstrating the depth of diffusion of lithium atoms into a current collector to form a nano-scale solid solution interface in accordance with various aspects of the present disclosure;

FIG. 4 is a flowchart illustrating another example method for forming an electrode assembly having a nano-scale solid solution interface binding a current collector and an electroactive material layer in accordance with various aspects of the present disclosure; and

FIG. 5 is a flowchart illustrating another example method for forming an electrode assembly having a nano-scale solid solution interface binding a current collector and an electroactive material layer in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including electrode assemblies prepared using diffusion coupling. Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

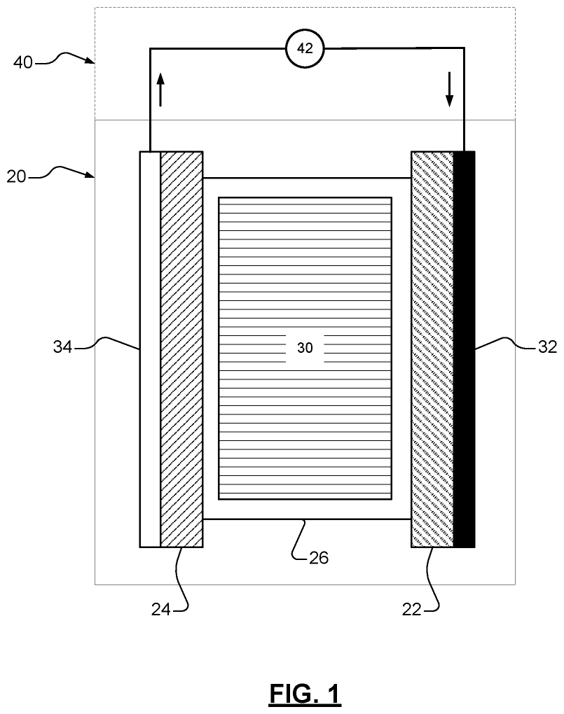

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode (which can also be referred to as a negative electroactive material layer) 22. The first current collector 32 together with the negative electrode 22 may be referred to as a negative electrode assembly. Although not illustrated, the skilled artisan will appreciate that, in certain variations, negative electrodes 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, as further detailed below the negative electrode 22 may be coupled to the first current collector 32 using diffusion coupling, such that negative electrode 22 and the first current collector 32 are chemically bond, increasing adhesion, and as such, electrical contact. The first current collector 32 may be a metal foil, metal grid or screen, metal foams, expanded metal, or perforated metal foils comprising copper including, for example, pure copper, as well as copper alloys, such as copper-zinc (brass) alloys, copper-tin (bronze) alloys, copper-lead alloys, copper-gold alloys, copper-indium alloys, copper-nickel alloys, and/or copper-silicon alloys.

A second current collector 34 (e.g., a positive current collector) may be positioned at or near the positive electrode (which can also be referred to as positive electroactive material layer) 24. The second current collector 34 together with the positive electrode 24 may be referred to as a positive electrode assembly. Although not illustrated, the skilled artisan will appreciate that, in certain variations, positive electrodes 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, expanded metal, or perforated metal foils comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: NOMEX™ meta-aramid (e.g., an aromatic polyamide formed from a condensation reaction from monomers m-phenylenediamine and isophthaloyl chloride), ARAMID aromatic polyamide, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22. In each instance, the solid-state electrolyte and/or semi-solid-state electrolyte includes the electrolyte additive as detailed above.

The positive electrode (which can also be referred to as a positive electroactive material layer) 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In further variations, the positive electrode 24 may be a composite electrode including a combination of positive electroactive materials. For example, the positive electrode 24 may include a first positive electroactive material and a second electroactive material. A ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may be optionally intermingled with an electronically conductive material (i.e., conductive additive) that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode (which can also be referred to as the negative electroactive material layer) 22 is formed from a lithium host material that is capable of functioning as a negative terminal of a lithium-ion battery. For example, the negative electroactive material layer 22 may include a lithium-containing negative electroactive material, such as a lithium alloy and/or a lithium metal. In certain variations, as mentioned above, the lithium metal foil may be coupled to the first current collector 32 using diffusion coupling, such that negative electroactive material layer 22 and the first current collector 32 are chemically bond, increasing adhesive, and as such, electrical contact. For example, a nano-scale solid solution interface may bind the negative electroactive material layer 22 and the first current collector 32.

The nano-scale solid solution interface may be defined by a region between the first current collector 32 and the negative electroactive material layer 22 defined by lithium metal (e.g., having greater than or equal to about 99% by mass lithium). The nano-scale solid solution interface is thus defined as a discrete region at the surface of the first current collector 32 having lithium atoms (from the negative electroactive material layer 22) diffused partially therein. For example, the first current collector 32 (as a foil current collector or a three-dimensional foil collector (e.g., meshes)) may have an average thickness greater than or equal to about 3 micrometers (μm) to less than or equal to about 80 μm, optionally greater than or equal to about 3 μm to less than or equal to about 60 μm, optionally greater than or equal to about 3 μm to less than or equal to about 15 μm, and in certain aspects, optionally greater than or equal to about 6 μm to less than or equal to about 12 μm; and the lithium atoms may diffuse into the first current collector 32 at least about 0.05%, optionally greater than or equal to about 0.05% to less than or equal to about 1.5%, optionally greater than or equal to about 0.05% to less than or equal to about 0.4%, and in certain aspects, optionally greater than or equal to about 0.1% to less than or equal to about 0.25%, of a total thickness of the first current collector 32. In this manner, the nano-scale solid solution interface has a distinct composition from the remaining current collector material in having lithium ions present (optionally in a concentration gradient) in the metal forming the first current collector 32. The first current collector 32 may include copper alloys (e.g., copper-zinc (brass) alloys, copper-tin (bronze) alloys, copper-lead alloys, copper-gold alloys, copper-indium alloys, copper-nickel alloys, and/or copper-silicon alloys). The metal material may thus form additional alloys or inter-metallics with the diffused lithium and thus form chemical bonds that further enhance bonding of the negative electrode 22 and the first current collector 32.

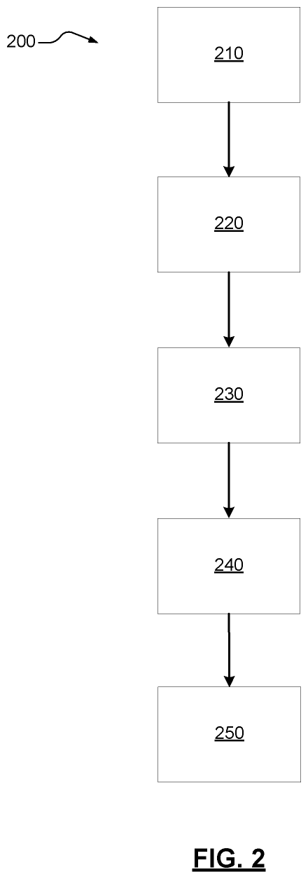

In various aspects, the present disclosure provides methods for forming electrode assemblies including electroactive material layers disposed adjacent to current collectors and having improved adhesive and electrical contact between the electroactive material layers and the current collectors. For example, in certain variations, as illustrated in FIG. 2, an example method 200 for forming an electrode assembly, like the negative electrode assembly (including the negative electrode 22 with the first current collector 32) as illustrated in FIG. 1, may be a post-fabrication heat treatment method that includes obtaining 220 a precursor electrode assembly and heat treating 230 the precursor electrode assembly. The precursor electrode assembly may include an electroactive material layer (for example, a lithium metal foil) disposed near or on one or more sides of a current collector. The electroactive material layer may be disposed, for example, using a physical vapor deposition (PVD) process, an electrodeposition process, a lamination process, or the like. In certain variations, the method 200 may include preparing 210 the precursor electrode assembly.

In each variation, the heat treatment 230 may include heating (for example using a heating stage (in an inert or dry atmosphere) and/or infrared (or other) radiation and/or resistive heating (AC or DC)) the electrode to a temperature that is less than the melting temperature of both the lithium (e.g., melting point of lithium is about 180° C.) and the current collector (e.g., melting point of copper is about 1080° C.). For example, the electrode assembly may be heated to a temperature greater than or equal to about 120° C. to less than or equal to about 180° C., and in certain aspects, optionally greater than or equal to about 150° C. to less than or equal to about 170° C. for a period greater than or equal to about 30 seconds to less than or equal to about 3 hours, and in certain aspects, optionally greater than or equal to about 10 minutes to less than or equal to about 30 minutes. In certain variations, the heat treatment may occur post-fabrication and spools heated post-fabrication and winding.

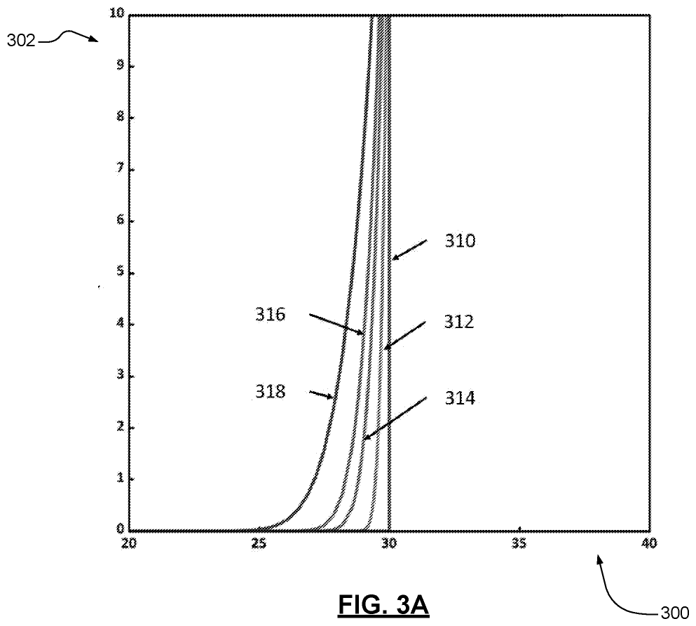

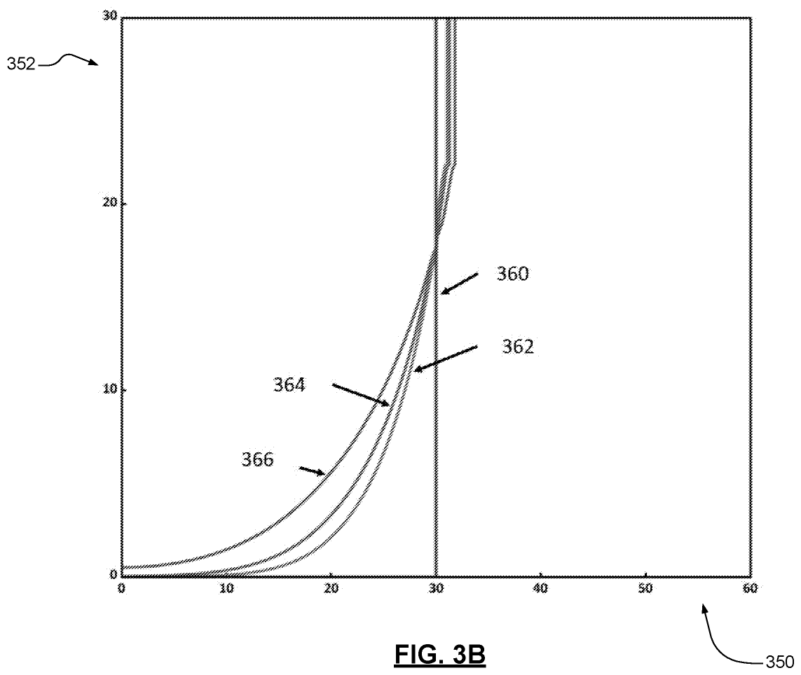

In each instance, during the heat treatment, lithium atoms can permeate the current collector via solid state diffusion, where the depth of the diffusion is dependent upon the temperature of electrode and current collector and the time the electrode and current collector are held at the elevated temperature. For example, FIGS. 3A and 3B are graphical illustrations demonstrating the diffusion of lithium atoms into a pure copper current collector at 170° C. at different times. FIG. 3A illustrate the diffusion of the lithium atoms at 0 seconds (see reference line 310), 1 second (see reference line 312), 5 seconds (see reference line 314), 10 seconds (see reference line 316), and 30 seconds (see reference line 318), where the x-axis 300 represents distance (nm), and the y-axis 302 represents mole percent lithium. FIG. 3B illustrates the diffusion of the lithium atoms at 0 minutes (see reference line 360), 10 minutes (see reference line 362), 15 minutes (see reference line 364), and 30 minutes (see reference link 366), where the x-axis 350 represents distance (nm), and the y-axis 352 represents mole percent lithium. In certain variations, the diffusion of the lithium may be dependent upon the foil grain structure of the current collector. For example, lithium may diffuse faster/deeper into the current collector at metal grain boundaries. As such, current collectors having more highly dense grain structures (e.g., small grains, lots of grain boundaries) will have deeper penetration of lithium. However, the lithium will diffuse preferentially at the grain boundaries, which may result in a less homogeneous lithium distribution.

In each variation, following the heat treatment 230, the method 200 may include cooling 240 the formed electrode assembly to room temperature (e.g., greater than or equal to about 20° C. to less than or equal to about 22° C.). Importantly, a short cooling window may result in sharper interfaces, while a slow cooling window may result in a more diffused interface. The method 200 may also include aligning 250 the formed electrode assembly with other cell components (e.g., positive electrode assembly and separator) to form (or assemble) as cell. In certain variations, the cooling 240 and the aligning 250 may occur concurrently. In other variations, the cooling 240 and the aligning 250 may occur consecutively.

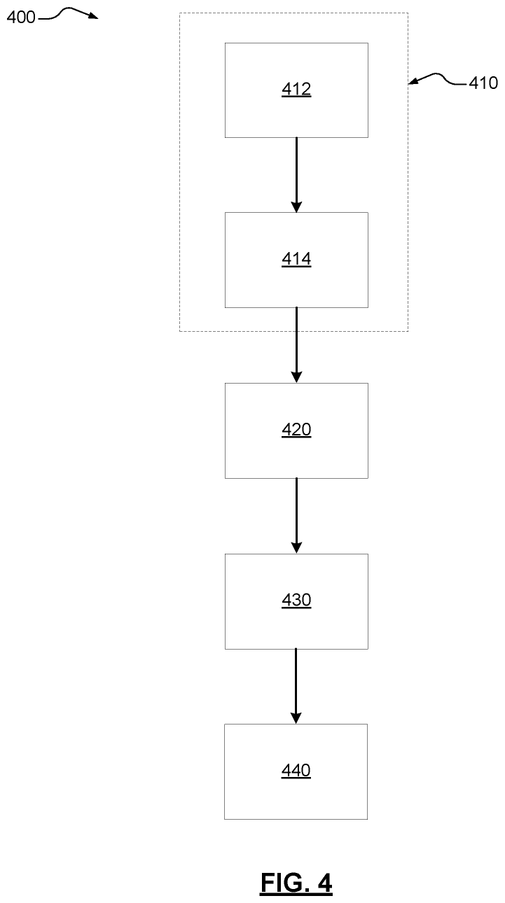

In various aspects, as illustrated in FIG. 4, an example method 400 for forming an electrode assembly, like the negative electrode assembly (including the negative electrode 22 with the first current collector 32) as illustrated in FIG. 1, may be a two-step method that includes forming 410 a current collector having a nano-scale solid solution interface and disposing 420 a lithium metal electrode (having, for example, an average thickness greater than or equal to about 1 μm to less than or equal to about 100 μm, optionally greater than or equal to about 10 μm to less than or equal to about 70 μm, and in certain aspects, optionally greater than or equal to about 20 μm to less than or equal to about 70 μm) onto the nano-scale solid-solution surface of the current collector.

Forming the current collector having the nano-scale solid solution surface may include disposing 412 an ultrathin lithium metal film onto or near a surface of the current collector. The ultrathin lithium metal film may have an average thickness greater than or equal to about 1 nanometer (nm) to less than or equal to about 110 nm, and in certain aspects, optionally greater than or equal to about 5 nm to less than or equal to about 25 nm, and in certain aspects, disposing the ultrathin lithium metal film onto or near the surface of the current collector may include an electrodeposition process.

Forming the current collector having the nano-scale solid solution surface may further include heating 414 the as disposed ultrathin lithium metal film such that the lithium in its entirety diffuses into the current collector via solid state diffusion and forms the modified current collector having the nano-scale solid solution surface. In certain variations, the as disposed ultrathin lithium metal film may be heated (for example using a heating stage (in an inert or dry atmosphere) and/or infrared (or other) radiation and/or resistive heating (AC or DC)) to a temperature greater than or equal to about 120° C. to less than or equal to about 180° C., and in certain aspects, optionally greater than or equal to about 150° C. to less than or equal to about 170° C. for a period greater than or equal to about 1 second to less than or equal to about 1 hour, and in certain aspects, optionally greater than or equal to about 5 minutes to less than or equal to about 10 minutes. As discussed above, the diffusion of the lithium into the precursor current collector may be dependent upon the foil grain structure of the current collector.

In certain variations, the method 400 may include cooling 430 the current collector having a nano-scale solid solution interface to room temperature (e.g., greater than or equal to about 20° C. to less than or equal to about 22° C.) prior to disposing the lithium metal electrode onto the nano-scale solid-solution surface of the current collector. In certain variations, after placement of the lithium metal electrode onto the nano-scale solid-solution surface of the current collector, the method 400 may include aligning 440 the formed electrode assembly with other cell components (e.g., positive electrode assembly and separator) to form (or assemble) as cell.

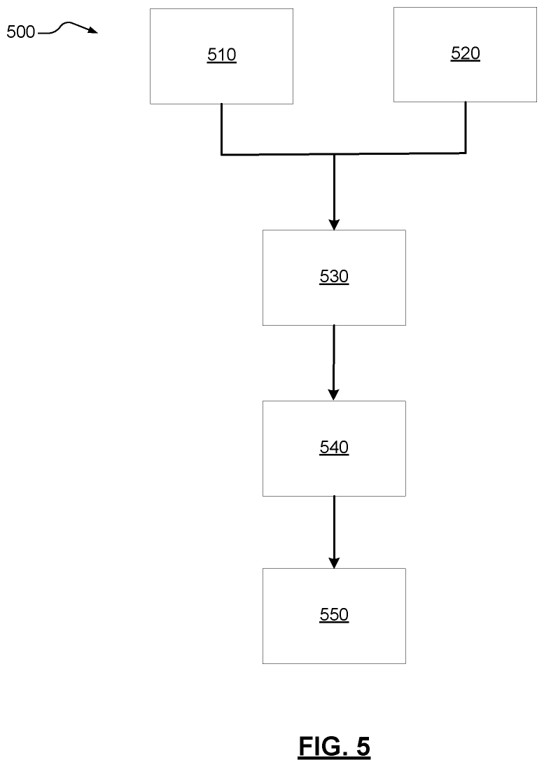

In various aspects, as illustrated in FIG. 5, an example method 500 for forming an electrode assembly, like the negative electrode assembly (including the negative electrode 22 with the first current collector 32) as illustrated in FIG. 1, may be a molten method that includes disposing 530 (for example, coating) molten lithium onto one or more surfaces of a heated current collector to form a precursor assembly. In certain variations, the method 500 may include preparing 510 the molten lithium and/or heating 520 the current collector. The molten lithium may be prepared 510 and the current collector 520 heated concurrently or consecutively. The molten lithium may have a temperature greater than or equal to about 180° C. to less than or equal to about 250° C. The current collector may be heated (for example using a heating stage (in an inert or dry atmosphere) and/or infrared (or other) radiation and/or resistive heating (AC or DC)) to limit premature cooling and may have a temperature greater than or equal to about 120° C. to less than or equal to about 250° C., and in certain aspects, optionally greater than or equal to about 120° C. to less than or equal to about 180° C.

In various aspects, the method 500 further includes cooling 540 the precursor assembly such that the lithium diffuses into the current collectors forming the negative electrode assembly having the nano-scale solid solution interface. The precursor assembly may be cooled 540 (for example in the open air or using a forced air cooling (FAC) process that includes the use of gases like argon that will not react with lithium) at a cooling rate that is dependent upon ventilation, internal heat, airflow, and the like, but may be, for example, greater than or equal to about 5° C./sec to less than or equal to about 50° C./sec. In certain variations, following the cooling 540, the method 500 may include aligning 550 the formed electrode assembly with other cell components (e.g., positive electrode assembly and separator) to form (or assemble) as cell.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode assembly for an electrochemical cell that cycles lithium ions, the electrode assembly comprising:
a current collector;
a lithium metal foil; and
a solid solution interface chemically bonding the current collector and the lithium metal foil, the solid solution interface comprising a first portion of the current collector impregnated with lithium atoms diffused from the lithium metal foil.

2. The electrode assembly of claim 1, wherein the current collector has an average thickness greater than or equal to about 3 μm to less than or equal to about 80 μm, and the solid solution interface impregnates greater than or equal to about 0.05% to less than or equal to about 1.5% of the average thickness of the current collector.

3. The electrode assembly of claim 1, wherein the lithium metal foil has an average thickness greater than or equal to about 1 micrometer to less than or equal to about 100 micrometers.

4. The electrode assembly of claim 1, wherein the current collector comprises copper.

5. The electrode assembly of claim 4, wherein the current collector further comprises zinc, tin, lead, gold, indium, nickel, silicon, or combinations thereof.

6. A method of preparing an electrode assembly for an electrochemical cell that cycles lithium ions, the method comprising:
heating a precursor electrode assembly comprising a current collector and a lithium metal film disposed on one or more surfaces of the current collector to a temperature that is less than a melting point of lithium, so that lithium atoms from the lithium metal film diffuse into the current collector during the heating forming a solid solution interface chemically binding the current collector and the lithium metal foil to form the electrode assembly.

7. The method of claim 6, wherein the temperature is greater than or equal to about 120° C. to less than or equal to about 180° C.

8. The method of claim 6, wherein the temperature is maintained for a period greater than or equal to about 30 seconds to less than or equal to about 3 hours.

9. The method of claim 6, wherein the lithium metal film has a thickness greater than or equal to about 1 micrometer to less than or equal to about 100 micrometers.

10. The method of claim 9, wherein the method further comprises:
preparing the precursor electrode assembly by disposing the lithium metal film onto the one or more surfaces of the current collector using a physical vapor deposition (PVD) process, an electrodeposition process, or a lamination process.

11. The method of claim 6, wherein the lithium metal film is an ultrathin lithium metal film having an average thickness greater than or equal to about 1 nanometer to less than or equal to about 110 nanometers.

12. The method of claim 11, wherein the method further comprises:
preparing the electrode assembly by disposing the ultrathin lithium metal film onto the one or more surfaces of the current collector using an electrodeposition process.

13. The method of claim 11, wherein the average thickness is a first average thickness, the ultrathin lithium metal film is a first lithium metal film, and the method further comprises:
after the heating, disposing a second lithium metal film onto the solid solution interface, the second lithium metal film having a second average thickness that is greater than the first average thickness.

14. The method of claim 13, wherein the second average thickness is greater than or equal to about 1 micrometers to less than or equal to about 100 micrometers.

15. The method of claim 6, wherein the current collector has an average thickness greater than or equal to about 5 micrometers to less than or equal to about 80 micrometers, and the solid solution interface impregnates greater than or equal to about 0.05% to less than or equal to about 1.5% of the average thickness of the current collector.

16. The method of claim 6, wherein the current collector comprises copper.

17. A method of preparing an electrode assembly for an electrochemical cell that cycles lithium ions, the method comprising:
disposing a molten lithium onto one or more surfaces of a heated current collector to form a precursor electrode assembly; and
cooling the precursor electrode assembly to form a lithium metal layer that is chemically bonded to the one or more surfaces of the current collector via a solid solution interface and defines the electrode assembly.

18. The method of claim 17, wherein during the disposing, the molten lithium has a first temperature greater than or equal to about 180° C. to less than or equal to about 250° C., and the heated precursor current collector has a second temperature greater than or equal to about 120° C. to less than or equal to about 250° C.

19. The method of claim 17, wherein the cooling occurs at a rate greater than or equal to about 5° C./sec to less than or equal to about 50° C./sec.

20. The method of claim 17, wherein the current collector has an average thickness greater than or equal to about 5 micrometers to less than or equal to about 80 micrometers, and the solid solution interface impregnates greater than or equal to about 0.05% to less than or equal to about 1.5% of the average thickness of the current collector.
